(19) United States
(12) Patent Application Publication
(10) Pub. No.: US 2015/0078436 A1
(43) Pub. Date: Mar. 19, 2015

(54) IMAGE ENCODING APPARATUS, IMAGE DECODING APPARATUS AND IMAGE TRANSMISSION SYSTEM

(71) Applicant: KABUSHIKI KAISHA TOSHIBA, Minato-ku (JP)

(72) Inventors: Takeshi Chujoh, Kawasaki (JP); Hiroyuki Kobayashi, Tsukubamirai (JP); Saori Asaka, Tokyo (JP); Tomoya Kodama, Kamasaki (JP)

(73) Assignee: KABUSHIKI KAISHA TOSHIBA, Minato-ku (JP)

(21) Appl. No.: 14/488,682

(22) Filed: Sep. 17, 2014

(30) Foreign Application Priority Data
Sep. 18, 2013 (JP) 2013-193427

(51) Int. Cl. H04N 19/134

(52) U.S. Cl. CPC H04N 19/134; H04N 19/50; H04N 19/61; H04N 19/625; H04N 19/91
USPC 375/240.02

(57) ABSTRACT

According to an embodiment, an image encoding apparatus includes a key information generator, a key image generator and an image encoder. The key information generator generates key information. The key image generator generates a key image based on a base image and the key information. The base image includes one or more images. The image encoder generates encoded data by encoding an input image using the key image.

### CROSS-REFERENCE TO RELATED APPLICATIONS

This application is based upon and claims the benefit of priority from Japanese Patent Application No. 2013-193427, filed Sep. 18, 2013, the entire contents of which are incorporated herein by reference.

### FIELD

Embodiments relate to image transmission.

### BACKGROUND

When an image is transmitted to a remote location, a third person may intercept the communication to peek at or alter the contents of the transmitted image. To prevent this problem occurring, for example, encryption, scrambling, or the like has been utilized to ensure the communication is secure.

However, as the security ensured by encryption or scrambling relies on computational complexity, the security is likely to be undermined once the mechanism of the encryption or scrambling is revealed. That is, the third person may perform decryption or descrambling to intercept the communication and consequently peek at or alter the contents of the transmitted image.

### BRIEF DESCRIPTION OF THE DRAWINGS

FIG. 1 is a block diagram illustrating an image transmission system according to a first embodiment;

FIG. 2 is a block diagram illustrating a key image generation unit and a key information generation unit both shown in FIG. 1;

FIG. 3 is a block diagram illustrating the key image generation unit and the key information generation unit both shown in FIG. 1;

FIG. 4 is a block diagram illustrating an image transmission system according to a second embodiment;

FIG. 5 is a block diagram illustrating a key image generation unit and a key information generation unit both shown in FIG. 4;

FIG. 6 is a block diagram illustrating an image transmission system according to a third embodiment;

FIG. 7 is a block diagram illustrating a key information generation unit in FIG. 6;

FIG. 8 is a block diagram illustrating an image encoding unit included in the image transmission system according to the first embodiment;

FIG. 9 is a block diagram illustrating an image decoding unit included in the image transmission system according to the first embodiment;

FIG. 10 is a block diagram illustrating an image encoding unit included in an image transmission system according to a fourth embodiment;

FIG. 11 is a block diagram illustrating an image decoding unit included in the image transmission system according to the fourth embodiment;

FIG. 12 is a block diagram illustrating an image encoding unit included in an image transmission system according to a fifth embodiment;

FIG. 13 is a block diagram illustrating an image decoding unit included in the image transmission system according to the fifth embodiment;

FIG. 14 is a diagram illustrating hardware implementing an image encoding apparatus, an image decoding apparatus, and key information generation apparatus all included in the image transmission system according to each of the embodiments.

### DETAILED DESCRIPTION

Embodiments will be described below with reference to the drawings.

According to an embodiment, an image encoding apparatus includes a key information generator, a key image generator and an image encoder. The key information generator generates key information. The key image generator generates a key image based on a base image and the key information. The base image includes one or more images. The image encoder encodes an input image using the key image and generates encoded data by encoding an input image using the key image.

In the description below, elements identical or similar to described elements are denoted by identical or similar reference numerals, and duplicate descriptions are basically omitted.

### First Embodiment

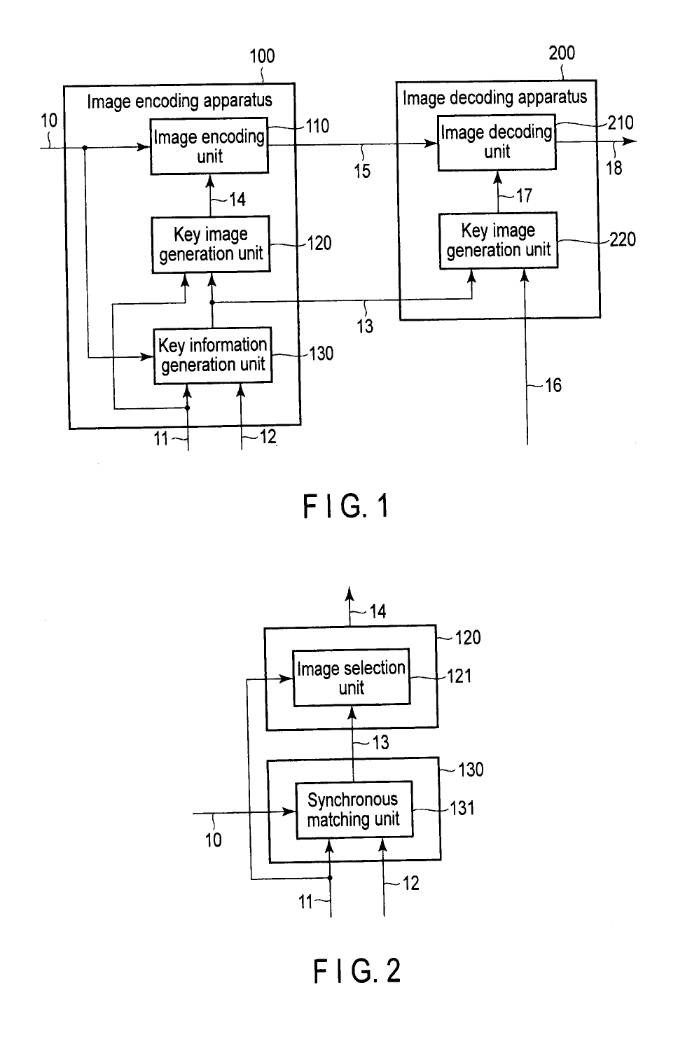

As illustrated in FIG. 1, an image transmission system according to a first embodiment includes an image encoding apparatus 100 and an image decoding apparatus 200. The image encoding apparatus 100 includes an image encoding unit 110, a key image generation unit 120, and a key information generation unit 130. The image decoding apparatus 200 includes an image decoding unit 210 and a key image generation unit 220.

The image encoding unit 110 acquires an input image 10 and receives a key image 14 from the key image generation unit 120. As described below, the image encoding unit 110 generates encoded data 15 by encoding the input image 10 using the key image 14. The image encoding unit 110 transmits the encoded data 15 to the image decoding apparatus 200. The encoded data 15 may be transmitted to the image decoding apparatus 200 by wireless or wired communication or transmitted to the image decoding apparatus 200 via a recording medium.

For the encoded data 15, security is ensured by encoding using the key image 14. That is, not only the encoded data 15 but also the key image 14 is needed to substantially restore the input image 10. Hence, even if a third person intercepts the communication to acquire the encoded data 15, peeking at or altering the contents of the input image 10 is difficult unless the third person can acquire the key image 14.

The key image generation unit 120 receives a base image 11 and also receives key information 13 from the key information generation unit 130. The key image generation unit 120 generates a key image 14 based on the base image 11 and the key information 13. The key image generation unit 120 outputs the key image 14 to the image encoding unit 110.

Specifically, the base image 11 may be one or more still images or a moving picture including a plurality of image frames. In view of improvement of a coding rate, the base image 11 preferably contains an image likely to be similar to the input image 10 in terms of, for example, an imaging position and an imaging direction. For example, if the input image 10 is an image taken by a camera mounted on a first moving body (for example, a train or a bus) while the first moving body is traveling along a predetermined route, the base image 11 may be a past image taken by a camera mounted on a second moving body (which may be identical to or different from the first moving body) while the second moving body is traveling along the predetermined route.

The key information 13 includes identification information indicative of a part (selected image) of the base image 11 selected as a base for the key image 14. The identification information may be, for example, a frame number when the base image 11 is a moving picture. The key information 13 may further include a correction parameter for correcting the selected image.

The key image 14 may be the selected image itself or the selected image on which image processing as described below has been performed.

When the selected image is different from the input image 10 in format, the key information generation unit 120 may generate a key image 14 by converting the format of the selected image into the same format as that of the input image 10. The format as used herein refers to, for example, an image size, a pixel bit length, or a color format.

When the key information 13 includes the correction parameter, the key image generation unit 120 may generate a key image 14 by using the correction parameter to correct the selected image. The key image generation unit 120 may perform gamma correction on the selected image using a gamma value included in the correction parameter. The key image generation unit 120 may perform histogram conversion using histogram information on the input image 10 included in the correction parameter. The key image generation unit 120 may execute a Wiener filter process on the selected image using filter coefficients (which can be designed based on the selected image and the input image 10) for the Wiener filter included in the correction parameter. The key image generation unit 120 may perform weighted prediction on the selected image using a weighting factor and an offset value both included in the correction parameter, in order to correct, for example, brightness. The key image generation unit 120 may perform geometric conversion on the selected image using a parameter value for the geometric conversion included in the correction parameter, in order to correct, for example, the imaging position. The key image generation unit 120 may perform various image corrections not illustrated herein.

The key information generation unit 130 acquires the input image 10 and receives the base image 11 and supplemental information 12. For example, based on the supplemental information 12, the key information generation unit 130 searches the base image 11 for an image similar to the input image 10 to generate key information 13 including identification information indicative of the searched-for image (which is the same as the selected image). Moreover, the key information generation unit 130 may generate a correction parameter for correcting the selected image and include the correction parameter in the key information 13.

The supplemental information 12 may include information on, for example, the imaging position, the imaging direction, an imaging date, and an imaging time. These pieces of information are useful for the key information generation unit 130 to search the base image 11 for an image similar to the input image 10. For example, the information on the imaging position and the imaging direction is useful for searching the base image 11 for an image that is similar to the input image 10 in terms of a subject (particularly a background). The information on the imaging date and the imaging time is useful for searching the base image 11 for an image that is similar to the input image 10 in terms of sunshine conditions.

The key information generation unit 130 may search the base image 11 for an image similar to the input image 10 without utilizing the supplemental information 12. Alternatively, the key information generation unit 130 may select any part of the base image 11 regardless of the input image 10. However, in view of improvement of the coding rate, an image that is similar to the input image 10 is preferably searched for. Furthermore, in view of improvement of search efficiency, the supplemental information 12 is preferably utilized.

The key information generation unit 130 outputs the key information 13 to the key image generation unit 120. Moreover, the key information generation unit 130 transmits the key information 13 to the image decoding apparatus 200. The key information 13 may be transmitted to the image decoding apparatus 200 by wireless or wired communication or transmitted to the image decoding apparatus 200 via a recording medium.

The key information 13 may be transmitted separately from or along with the encoded data 15. For example, the key information 13 and the encoded data 15 are transmitted after being multiplexed and packetized. For transmission of the key information 13, it is possible that, for example, a framework for SEI (Supplemental Enhancement Information) in H.264/AVC or H.265/HEVC is utilized.

The key image generation unit 120 and the key information generation unit 130 may be designed as illustrated in FIG. 2. The key image generation unit 120 in FIG. 2 includes an image selection unit 121. The key information generation unit 130 includes a synchronous matching unit 131.

The synchronous matching unit 131 acquires the input image 10 and receives the base image 11 and the supplemental information 12. For example, based on the supplemental information 12, the synchronous matching unit 131 searches the base image 11 for an image similar to the input image 10 to generate key information 13 including identification information indicative of the searched-for image (which is the same as the selected image). The selected image may be, for example, an image included in the base image 11 and which is most similar to the input image 10. The synchronous matching unit 131 outputs the key information 13 to the image selection unit 121 shown in FIG. 2. Moreover, the synchronous matching unit 131 transmits the key information 13 to the image decoding apparatus 200.

The image selection unit 121 in FIG. 2 receives the base image 11 and also receives the key information 13 from the synchronous matching unit 131 shown in FIG. 2. The image selection unit 121 selects an image included in the base image 11 and which is indicated by the identification information included in the key information 13 (and which is the same as the selected image). The image selection unit 121 outputs the selected image to the image encoding unit 110 without any change, as the key image 14.

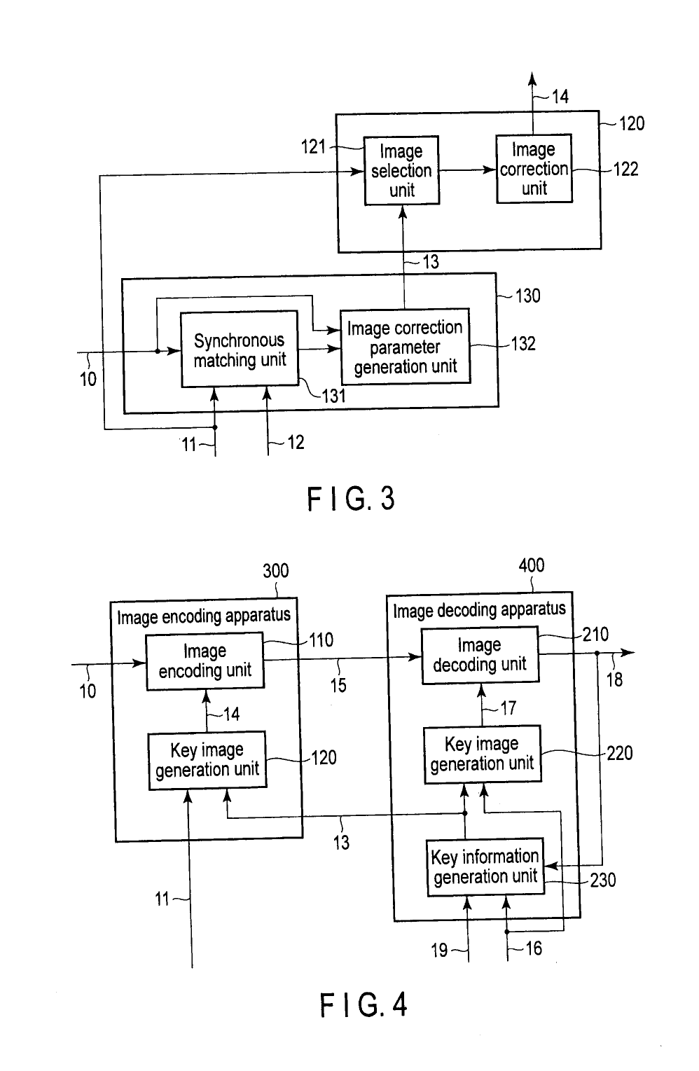

The key image generation unit 120 and the key information generation unit may be designed as illustrated in FIG. 3. The key image generation unit 120 in FIG. 3 includes the image selection unit 121 and an image correction unit 122. The key information generation unit 130 in FIG. 3 includes the synchronous matching unit 131 and an image correction parameter generation unit 132.

The synchronous matching unit 131 in FIG. 3 acquires the input image 10 and receives the base image 11 and the supplemental information 12. For example, based on the supplemental information 12, the synchronous matching unit 131 searches the base image 11 for an image similar to the input image 10 to generate identification information indicative of the searched-for image (which is the same as the selected image). The selected image may be, for example, an image included in the base image 11 and which is most similar to the input image 10. The synchronous matching unit 131 outputs the identification information and the selected image to the image correction parameter generation unit 132.

The image correction parameter generation unit 132 acquires the input image 10 and receives the identification information and the selected image from the synchronous matching unit 131. The image correction parameter generation unit 132 generates a correction parameter for correcting the selected image based on the input image 10 and the selected image. The image correction parameter generation unit 132 generates key information including the identification information and the correction parameter, and outputs the key information to the image selection unit 121 in FIG. 3. Moreover, the image correction parameter generation unit 132 transmits the key information 13 to the image decoding apparatus 200.

The image selection unit 121 in FIG. 3 receives the base image 11 and also receives the key information 13 from the image correction parameter generation unit 132. The image selection unit 121 selects an image included in the base image 11 and which is indicated by the identification information included in the key information 13 (and which is the same as the selected image). The image selection unit 121 outputs the selected image and the key information 13 to the image correction unit 122.

The image correction unit 122 receives the selected image and the key information 13 from the image selection unit 121. The image correction unit 122 generates a key image 14 by correcting the selected image using the correction parameter included in the key information 13. The image correction unit 122 outputs the key image 14 to the image encoding unit 110.

The image decoding unit 210 receives the encoded data 15 transmitted by the image encoding apparatus 100 and also receives a key image 17 from the key image generation unit 220. The image decoding unit 210 decodes the encoded data 15 using the key image 17, to generate an output image 18, as described below. The key image 17 is identical to the key image 14 generated in the image encoding apparatus 100. The output image 18 is obtained by substantially restoring the input image 10. The image decoding unit 210 supplies the output image 18 to, for example, a display apparatus not shown in the drawings.

The key image generation unit 220 receives a base image 16 and receives the key information 13 transmitted by the image encoding apparatus 100. The key image generation unit 220 may be identical or similar to the key image generation unit 120. The base image 16 is identical to the base image 11 used in the image encoding apparatus 100. The key image generation unit 220 generates a key image 17 based on the key information 13 and the base image 16. The key image generation unit 220 outputs the key image 17 to the image decoding unit 210.

As described above, the image encoding unit 110 generates encoded data 15 by encoding the input image 10. For example, as shown in FIG. 8, the image encoding unit 110 includes a subtraction unit 601, a transform and quantization unit 602, de-quantization and inverse transform unit 603, an addition unit 604, a loop filter unit 605, an image buffer unit 606, a predicted image generation unit 607, an entropy encoding unit 608, and an encoding control unit 609.

The subtraction unit 601 acquires the input image 10 and receives a predicted image from a predicted image generation unit 607. The subtraction unit 601 generates a prediction error by subtracting the predicted image from the input image 10. The subtraction unit 601 outputs the prediction error to the transform and quantization unit 602.

The transform and quantization unit 602 generates a transform coefficient by transforming the prediction error and generates a quantized transform coefficient by quantizing the transform coefficient in accordance with a quantization parameter. For the transformation of the prediction error, orthogonal transformation, for example, DCT (Discrete Cosine Transform) is used. The transform and quantization unit 602 outputs the quantized transform coefficient to the de-quantization and inverse transform unit 603 and the entropy encoding unit 608.

The de-quantization and inverse transform unit 603 receives the quantized transform coefficient from the transform and quantization unit 602. The de-quantization and inverse transform unit 603 restores the transform coefficient by de-quantizing the quantized transform coefficient in accordance with the quantization parameter. The de-quantization and inverse transform unit 603 restores the prediction error by inversely transforming the transform coefficient (this corresponds to an inverse process to transformation performed by the transform and quantization unit 602). For the inverse transformation of the transform coefficient, for example, inverse orthogonal transformation, for example, IDCT (Inverse DCT). The de-quantization and inverse transform unit 603 outputs the prediction error to the addition unit 604.

The addition unit 604 receives the prediction error from the de-quantization and inverse transform unit 603 and receives the predicted image from the predicted image generation unit 607. The addition unit 604 generates a local decoded image by adding the prediction error and the predicted image together. The addition unit 604 outputs the local decoded image to the loop filter unit 605.

The loop filter unit 605 receives the local decoded image from the addition unit 604. The loop filter unit 605 generates a filtered image by applying a loop filter process to the local decoded image. The loop filter process may be, for example, a de-blocking filter process. The loop filter unit 605 outputs the filtered image to the image buffer unit 606.

The image buffer unit 606 receives the filtered image from the loop filter unit 605 and the key image 14 from the key image generation unit 120. The image buffer unit 606 stores the filtered image and the key image 14 as reference images. The image buffer unit 606 outputs the reference image (which may include the key image 14) to the predicted image generation unit 607 as necessary.

The predicted image generation unit 607 acquires the input image 10, receives the reference image from the image buffer unit 606 and prediction control information from the encoding control unit 609. In accordance with the prediction control information, the predicted image generation unit 607 generates a predicted image using the input image 10 and the reference image. For example, the predicted image generation unit 607 generates a predicted image by performing intra prediction or performing motion compensating prediction on the reference image. The predicted image generation unit 607 outputs the predicted image to the subtraction unit 601 and the addition unit 604. Moreover, the predicted image generation unit 607 outputs prediction information (which includes, for example, motion vector information) on the predicted image to the entropy encoding unit 608.

The entropy encoding unit 608 receives the quantized transform coefficient from the transform and quantization unit 602 and the prediction information from the predicted image generation unit 607. The entropy encoding unit 608 generates encoded data 15 by performing entropy encoding on the quantized transform coefficient and the prediction information in accordance with syntax. The entropy encoding unit 608 outputs the encoded data 15 to the exterior of the image encoding unit 110. The entropy encoding is, for example, Huffman coding or arithmetic coding.

The encoding control unit 609 generates and outputs prediction control information to the predicted image generation unit 607. The encoding control unit 609 can control the operation of the predicted image generation unit 607 via the prediction control information. Specifically, the encoding control unit 609 can increase the frequency at which the key image 14 as a reference image is used to generate a predicted image. The dependence of decoding of the encoded data 15 on the key image 14 increases consistently with the frequency at which the key image 14 is used to generate a predicted image. That is, the third person, who is prevented from acquiring the key image 14, fails to easily comprehend the contents of the input image 10 even if the third person acquired the encoded data 15 because the predicted image needed to decode the encoded data 15 is frequently unknown to the third person.

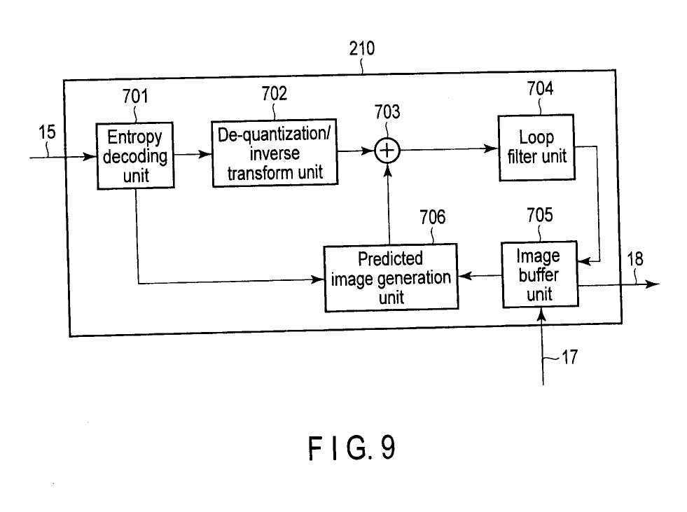

As described above, the image decoding unit 210 generates an output image 18 by decoding the encoded data 15 using the key image 17. For example, as shown in FIG. 9, the image decoding unit 210 includes an entropy decoding unit 701, a de-quantization and inverse transform unit 702, an addition unit 703, a loop filter unit 704, an image buffer unit 705, and a predicted image generation unit 706.

The entropy decoding unit 701 receives the encoded data 15 transmitted by the image encoding apparatus 100. The entropy decoding unit 701 restores the quantized transform coefficient and the prediction information (which includes, for example, motion vector information) by performing entropy decoding on the encoded data 15. The entropy decoding unit 701 outputs the quantized transform coefficient to the de-quantization and inverse transform unit 702, and outputs the prediction information to the predicted image generation unit 706.

The de-quantization and inverse transform unit 702 receives the quantized transform coefficient from the entropy decoding unit 701. The de-quantization and inverse transform unit 702 restores the transform coefficient by de-quantizing the quantized transform coefficient in accordance with the quantization parameter. The de-quantization and inverse transform unit 702 restores the prediction error by inversely transforming the transform coefficient (this corresponds to an inverse process to transformation performed in the image encoding unit 110). For the inverse transformation of the transform coefficient, for example, inverse orthogonal transformation, for example, IDCT is used. The de-quantization and inverse transform unit 702 outputs the prediction error to the addition unit 703.

The addition unit 703 receives the prediction error from the de-quantization and inverse transform unit 702 and the predicted image from the predicted image generation unit 706. The addition unit 703 generates a decoded image by adding the prediction error and the predicted image together. The addition unit 703 outputs the decoded image to the loop filter unit 704.

The loop filter unit 704 receives the decoded image from the addition unit 703. The loop filter unit 704 generates a filtered image by applying a loop filter process to the decoded image. The loop filter process may be, for example, a de-blocking filter process. The loop filter unit 704 outputs the filtered image to the image buffer unit 705.

The image buffer unit 705 receives the filtered image from the loop filter unit 704 and also receives the key image 17 from the key image generation unit 220. The image buffer unit 705 stores the filtered image and the key image 17 as reference images. The image buffer unit 705 outputs the reference images (which may include the key image 17) to the predicted image generation unit 706 as necessary. The image buffer unit 705 supplies the reference images (which does not include the key image 17) to, for example, a display apparatus not shown in the drawings, as the output image 18 in accordance with the order of display.

The predicted image generation unit 706 receives the reference images from the image buffer unit 705 and the prediction control information from the entropy decoding unit 701. The predicted image generation unit 706 generates a predicted image using the prediction information and the reference images. For example, the predicted image generation unit 706 generates a predicted image by performing intra prediction or performing motion compensating prediction on the reference image. The predicted image generation unit 706 outputs the predicted image to the addition unit 703.

As described above, in the image transmission system according to the first embodiment, the image encoding apparatus generates and transmits key information to the image decoding apparatus. Moreover, the image encoding apparatus encodes the input image using a key image generated based on the key information and transmits the encoded data to the image decoding apparatus. Although the key image is needed to substantially restore the input image from the encoded data, the third person has difficulty in acquiring the key image. Hence, the image transmission system allows the encoded data to be transmitted while preventing the third person from knowing the contents of the input image. That is, security of the transmitted image is ensured. The image decoding apparatus can substantially restore the input image by decoding the encoded data using the key image generated based on the transmitted key information.

### Second Embodiment

As illustrated in FIG. 4, an image transmission system according to a second embodiment includes an image encoding apparatus 300 and an image decoding apparatus 400. The image encoding apparatus 300 includes an image encoding unit 110 and a key image generation unit 120. The image decoding apparatus 400 includes an image decoding unit 210, a key image generation unit 220, and a key information generation unit 230.

The image encoding unit 110 in FIG. 4 is different from the image encoding unit 110 in FIG. 1 in that the image encoding unit 110 in FIG. 4 transmits encoded data 15 to the image decoding apparatus 400. The encoded data 15 may be transmitted to the image decoding apparatus 400 by wireless or wired communication or transmitted to the image decoding apparatus 400 via a recording medium. The key image generation unit 120 in FIG. 4 is different from the key image generation unit 120 in FIG. 1 in that the key image generation unit 120 in FIG. 4 receives key information 13 transmitted by the image decoding apparatus 400.

The image decoding unit 210 in FIG. 4 is different from the image decoding unit 210 in FIG. 1 in that the image decoding unit 210 in FIG. 4 receives the encoded data 15 transmitted by the image encoding apparatus 300. Moreover, the image decoding unit 210 supplies output image 18 not only to a display apparatus not shown in the drawings but also to the key information generation unit 230. The key image generation unit 220 in FIG. 4 is different from the key image generation unit 220 in FIG. 1 in that the key image generation unit 220 in FIG. 4 receives the key information 13 from the key information generation unit 230.

The key information generation unit 230 receives a base image 16 and supplemental information 19 and also receives the output image 18 from the image decoding unit 210. For example, based on the supplemental information 19, the key information generation unit 230 searches the base image 16 for an image similar to the output image 18 to generate key information 13 including identification information indicative of the searched-for image (which is an image (selected image) selected as a base for the key image 17). Moreover, the key information generation unit 230 may generate a correction parameter for correcting the selected image and include the correction parameter in the key information 13.

In short, the identification information described in the first embodiment is indicative of a selected image similar to the input image 10 to be encoded, whereas the identification information described in the present embodiment is indicative of a selected image similar to the output image 18 generated by decoding the previously encoded input image 10 instead of the input image 10 to be encoded.

The supplemental information 19 may include information on such as the imaging position, the imaging direction, the imaging date, and the imaging time. These pieces of information are useful for the key information generation unit 230 to search the base image 16 for an image similar to the output image 18. For example, the information on the imaging position and the imaging direction is useful for searching the base image 16 for an image that is similar to the output image 18 in terms of the subject (particularly the background). The information on the imaging date and the imaging time is useful for searching the base image 16 for an image that is similar to the output image 18 in terms of sunshine conditions.

The key information generation unit 230 may search the base image 16 for an image similar to the output image 18 without utilizing the supplemental information 19. Alternatively, the key information generation unit 230 may select any part of the base image 16 regardless of the output image 18. However, in view of improvement of the coding rate, an image that is similar to the output image 18 is preferably searched for. Furthermore, in view of improvement of the search efficiency, the supplemental information 19 is preferably utilized.

The key information generation unit 230 outputs the key information 13 to the key image generation unit 220. Moreover, the key information generation unit 230 transmits the key information 13 to the image encoding apparatus 300. The key information 13 may be transmitted to the image encoding apparatus 300 by wireless or wired communication or transmitted to the image encoding apparatus 300 via a recording medium.

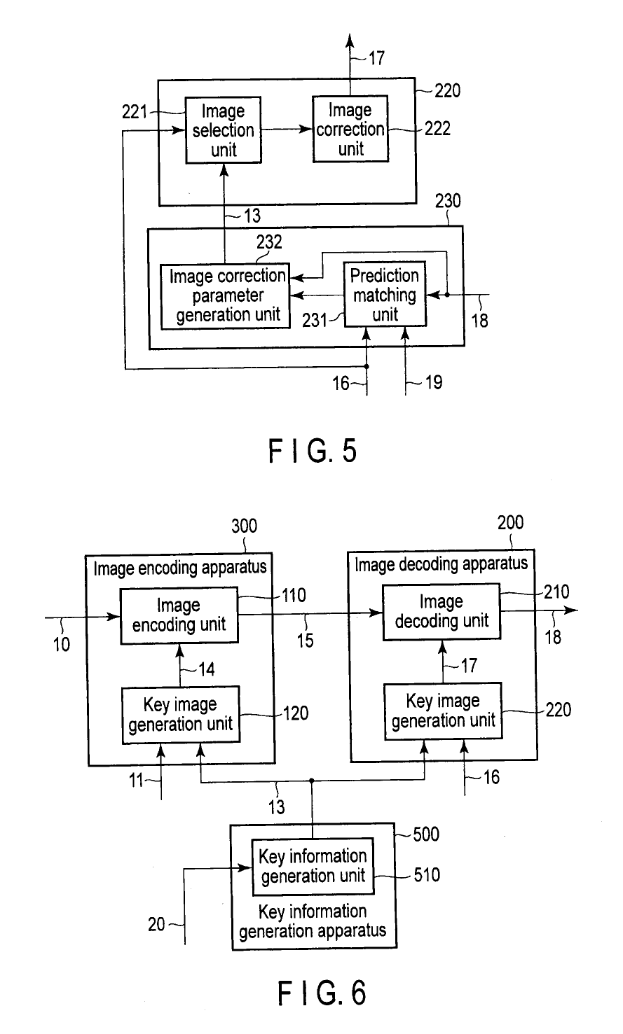

The key image generation unit 220 and the key information generation unit 230 may be designed as illustrated in FIG. 5. The key image generation unit 220 in FIG. 5 includes an image selection unit 221 and an image correction unit 222. The key information generation unit 230 in FIG. 5 includes a predictive matching unit 231 and an image correction parameter generation unit 232.

The predictive matching unit 231 receives the base image 16 and the supplemental information 19 and also receives the output image 18 from the image decoding unit 210. The predictive matching unit 231 searches the base image 16 for an image similar to the output image 18 based on the supplemental information 19 to generate identification information indicative of the searched-for image (which is the same as the selected image). The selected image may be, for example, an image included in the base image 16 and which is most similar to the output image 18. The predictive matching unit 231 outputs the identification information and the selected image to the image correction parameter generation unit 232.

The image correction parameter generation unit 232 receives the output image 18 from the image decoding unit 210 and receives the identification information and the selected image from the predictive matching unit 231. The image correction parameter generation unit 232 generates a correction parameter for correcting the selected image, based on the output image 18 and the selected image. The image correction parameter generation unit 232 then generates key information 13 including the identification information and the correction parameter, and outputs the key information 13 to the image selection unit 221. The image correction parameter generation unit 232 further transmits the key information 13 to the image encoding apparatus 300.

The image selection unit 221 receives the base image 16 and also receives the key information 13 from the image correction parameter generation unit 232. The image selection unit 221 selects an image included in the base image 16 and which is indicated by the identification information included in the key information 13 (and which is the same as the selected image). The image selection unit 221 outputs the selected image and the key information 13 to the image correction unit 222.

The image correction unit 222 receives the selected image and the key information 13 from the image selection unit 221. The image correction unit 222 generates a key image 17 by correcting the selected image using the correction parameter included in the key information 13. The image correction unit 222 outputs the key image 17 to the image decoding unit 210.

As described above, in the image transmission system according to the second embodiment, the image decoding apparatus generates and transmits key information to the image encoding apparatus. The image encoding apparatus encodes the input image using a key image generated based on the key information and transmits the encoded data to the image decoding apparatus. Although the key image is needed to substantially restore the input image from the encoded data, the third person has difficulty in acquiring the key image. Hence, the image transmission system allows the encoded data to be transmitted while preventing the third person from knowing the contents of the input image. That is, security of the transmitted image is ensured. The image decoding apparatus can substantially restore the input image by decoding the encoded data using the key image generated based on the key information.

### Third Embodiment

As illustrated in FIG. 6, an image transmission system according to a third embodiment includes an image encoding apparatus 300, an image decoding apparatus 200, and a key information generation apparatus 500. The image encoding apparatus 300 includes an image encoding unit 110 and a key image generation unit 120. The image decoding apparatus 200 includes an image decoding unit 210 and a key image generation unit 220. The key information generation apparatus 500 includes a key information generation unit 510.

The key image generation unit 120 in FIG. 6 is different from the key image generation unit 120 in FIG. 1 and FIG. 4 in that the key image generation unit 120 in FIG. 6 receives key information 13 transmitted by the key information generation apparatus 500. The key image generation unit 220 is different from the key image generation unit 220 in FIG. 1 and FIG. 4 in that the key image generation unit 220 according to the third embodiment receives the key information 13 transmitted by the key information generation apparatus 500.

The key information generation unit 510 receives a base image 20. The key information generation unit 510 selects any part of the base image 20 to generate key information 13 including identification information indicative of a selected image. The base image 20 is identical to the base image 11 used in the image encoding apparatus 300 and the base image 16 used in the image decoding apparatus 200.

The key information generation unit 510 transmits the key information 13 to the image encoding apparatus 300 and the image decoding apparatus 200. The key information 13 may be transmitted to the image encoding apparatus 300 and the image decoding apparatus 200 by wireless or wired communication or transmitted to the image encoding apparatus 300 and the image decoding apparatus 200 via a recording medium.

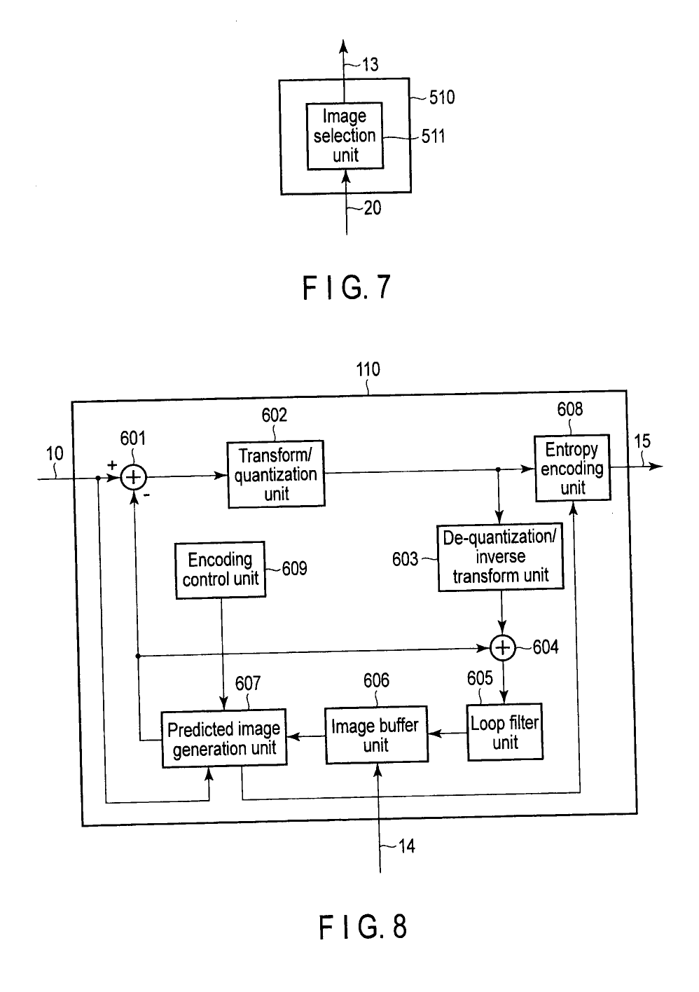

The key image generation unit 510 may be designed as illustrated in FIG. 7. The key information generation unit 510 in FIG. 7 includes an image selection unit 511. The image selection unit 511 receives the base image 20. The image selection unit 511 selects any part of the base image 20 to generate key information 13 including identification information indicative of a selected image. The image selection unit 511 transmits the key information 13 to the image encoding apparatus 300 and the image decoding apparatus 200.

As described above, in the image transmission system according to the third embodiment, the key information generation unit generates and transmits key information to the image encoding apparatus and the image decoding apparatus. The image encoding apparatus encodes the input image using a key image generated based on the key information and transmits the encoded data to the image decoding apparatus. Although the key image is needed to substantially restore the input image from the encoded data, the third person has difficulty in acquiring the key image. Hence, the image transmission system allows the encoded data to be transmitted while preventing the third person from knowing the contents of the input image. That is, security of the transmitted image is ensured. The image decoding apparatus can substantially restore the input image by decoding the encoded data using the key image generated based on the transmitted key information.

### Fourth Embodiment

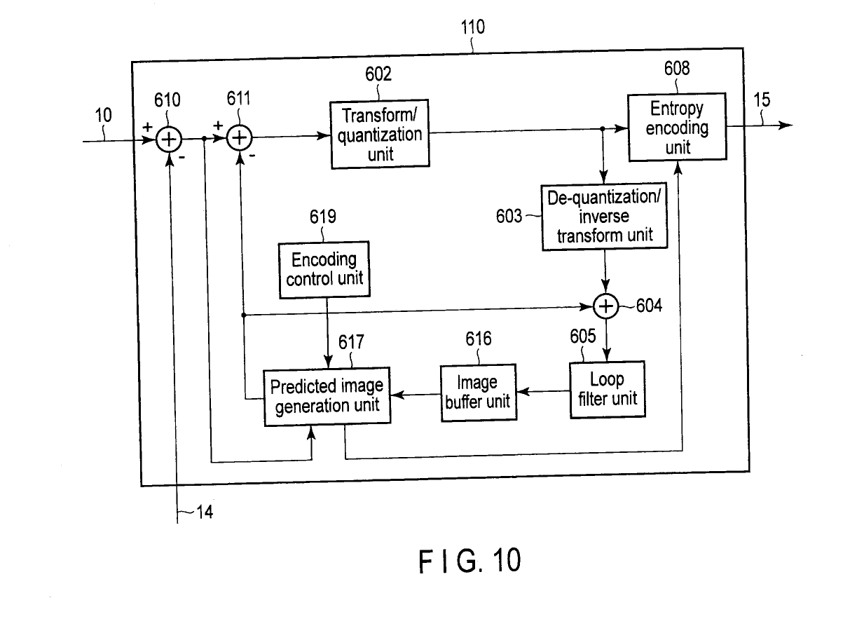

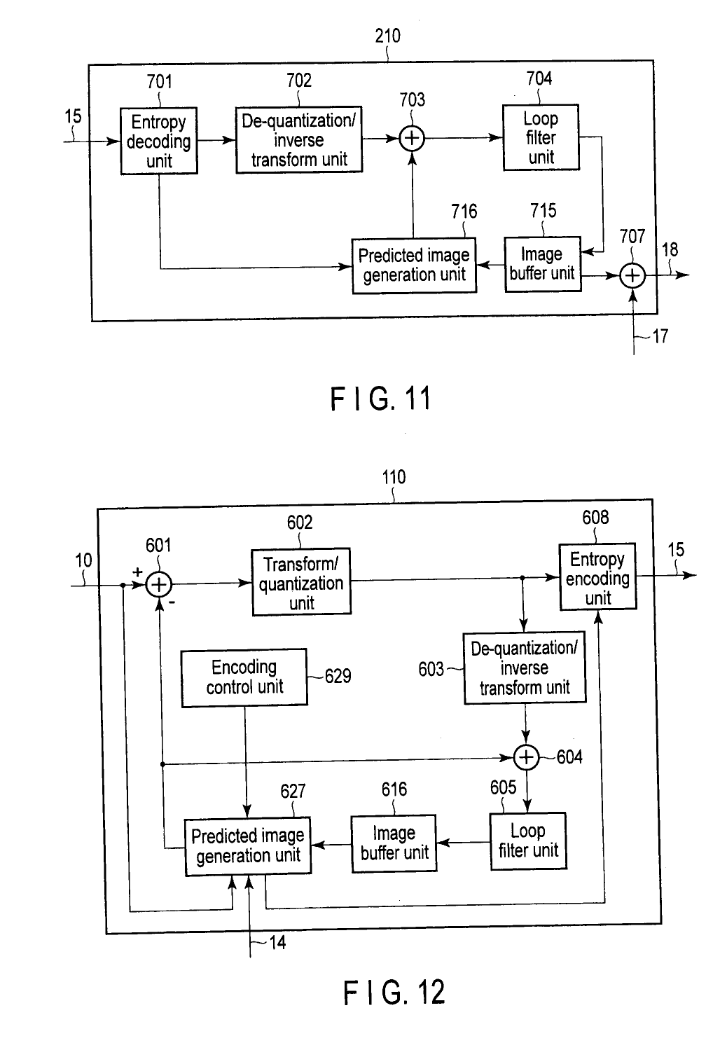

The image encoding unit 110 and the image decoding unit 210 described using FIG. 8 and FIG. 9, respectively, may be replaced with an image encoding unit 110 and an image decoding unit 210 described using FIG. 10 and FIG. 11, respectively.

The image encoding unit 110 illustrated in FIG. 10 includes a subtraction unit 611, a transform and quantization unit 602, de-quantization and inverse transform unit 603, an addition unit 604, a loop filter unit 605, an image buffer unit 616, a predicted image generation unit 617, an entropy encoding unit 608, an encoding control unit 619, and a subtraction unit 610.

The transform and quantization unit 602 in FIG. 10 is different from the transform and quantization unit 602 in FIG. 8 in that the transform and quantization unit 602 in FIG. 10 receives a prediction error from the subtraction unit 611 instead of the subtraction unit 601. The addition unit 604 in FIG. 10 is different from the addition unit 604 in FIG. 8 in that the addition unit 604 in FIG. 10 receives the prediction error from the predicted image generation unit 617 instead of the predicted image generation unit 607. The loop filter unit 605 in FIG. 10 is different from the loop filter unit 605 in FIG. 8 in that the loop filter unit 605 in FIG. 10 outputs a filtered image to the image buffer unit 616 instead of the image buffer unit 606. The entropy encoding unit 608 in FIG. 10 is different from the entropy encoding unit 608 in FIG. 8 in that the entropy encoding unit 608 in FIG. 10 receives prediction information (which includes, for example, motion vector information) from the predicted image generation unit 617 instead of the predicted image generation unit 607.

The subtraction unit 610 acquires an input image 10 and receives a key image 14 from the key image generation unit 120. The subtraction unit 610 generates a differential image by subtracting the key image 14 from the input image 10. The subtraction unit 610 outputs the differential image to the subtraction unit 611. That is, the image encoding unit 110 predictively codes the differential image instead of the input image 10. Therefore, the third person, who is prevented from acquiring the key image 14, fails to easily know the contents of the input image 10 even if the third person restores encoded data 15 (that is, restores the differential image) because the key image 14 needed to restore the input image 10 is unknown to the third person.

The subtraction unit 611 receives the differential image from the subtraction unit 610 and a predicted image from the predicted image generation unit 617. The subtraction unit 611 generates a prediction error by subtracting the predicted image from the differential image. The subtraction unit 611 outputs the prediction error to the transform and quantization unit 602.

The image buffer unit 616 receives a filtered image from the loop filter unit 605. The image buffer unit 616 stores the filtered image as a reference image. The image buffer unit 616 outputs the reference images to the predicted image generation unit 617 as necessary.

The predicted image generation unit 617 receives the differential image from the subtraction unit 610, the reference images from the image buffer unit 616, and prediction control information from the encoding control unit 619. The predicted image generation unit 617 generates a predicted image using the differential image and the reference images, in accordance with the prediction control information. For example, the predicted image generation unit 617 generates a predicted image by performing intra prediction or performing motion compensating prediction on the reference images. The predicted image generation unit 617 outputs the predicted image to the subtraction unit 611 and the addition unit 604. Moreover, the predicted image generation unit 617 outputs prediction information on the predicted image to the entropy encoding unit 608.

The encoding control unit 619 generates and outputs prediction control information to the predicted image generation unit 617. The encoding control unit 619 can control the operation of the predicted image generation unit 617 via the prediction control information.

The image decoding unit 210 illustrated in FIG. 11 includes an entropy decoding unit 701, a de-quantization and inverse transform unit 702, an addition unit 703, a loop filter unit 704, an image buffer unit 715, a predicted image generation unit 716, and an addition unit 707.

The entropy decoding unit 701 in FIG. 11 is different from the entropy decoding unit 701 in FIG. 9 in that the entropy decoding unit 701 in FIG. 11 outputs the prediction information to the predicted image generation unit 716 instead of the predicted image generation unit 706. The addition unit 703 in FIG. 11 is different from the addition unit 703 in FIG. 9 in that the addition unit 703 receives the predicted image from the predicted image generation unit 716 instead of the predicted image generation unit 706. The loop filter unit 704 in FIG. 11 is different from the loop filter unit 704 in FIG. 9 in that the loop filter unit 704 in FIG. 11 outputs the filtered image to the image buffer unit 715 instead of the image buffer unit 705.

The image buffer unit 715 receives the filtered image from the loop filter unit 704. The image buffer unit 715 stores the filtered image as a reference image. The image buffer unit 715 outputs reference images to the predicted image generation unit 716 as necessary. Moreover, the image buffer unit 715 outputs a reference image to the addition unit 707 as a differential image in accordance with the order of display.

The predicted image generation unit 716 receives the reference images from the image buffer unit 715 and the prediction information from the entropy decoding unit 701. The predicted image generation unit 716 generates a predicted image using the prediction information and the reference images. For example, the predicted image generation unit 716 generates a predicted image by performing intra prediction or performing motion compensating prediction on the reference images. The predicted image generation unit 716 outputs the predicted image to the addition unit 703.

The addition unit 707 receives a key image 17 from the key image generation unit 220 and also receives the differential image from the image buffer unit 715 in accordance with the order of display. The addition unit 707 generates an output image by adding the key image 17 and the differential image together. The addition unit 707 supplies the output image to, for example, a display apparatus not shown in the drawings.

### Fifth Embodiment

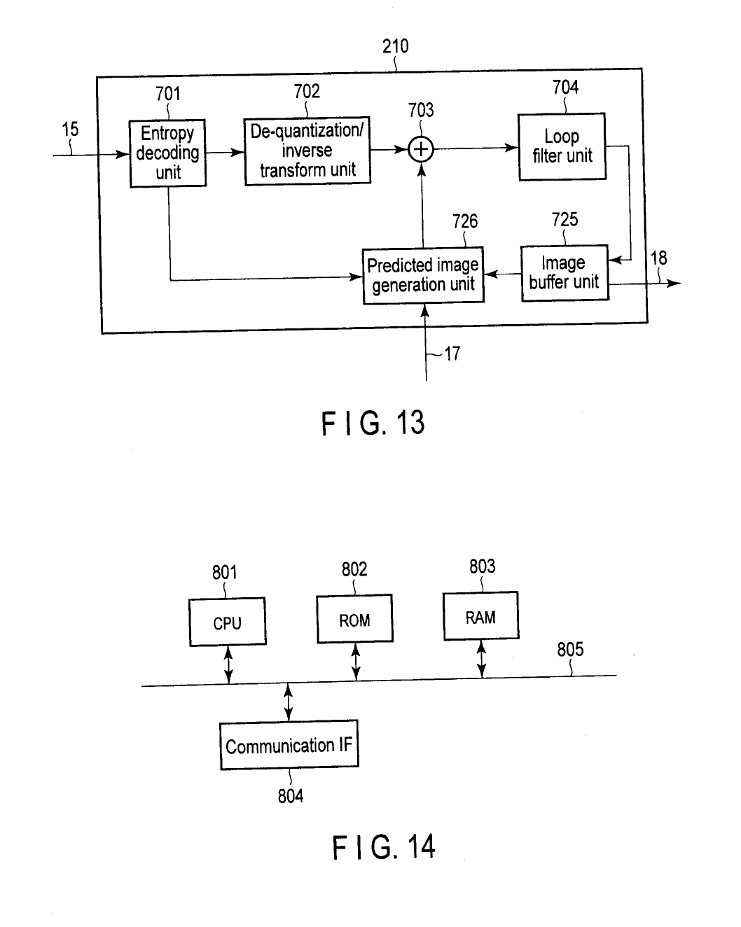

The image encoding unit 110 and the image decoding unit 210 described using FIG. 8 and FIG. 9, respectively, and FIG. 10 and FIG. 11, respectively, may be replaced with an image encoding unit 110 and an image decoding unit 210 described using FIG. 12 and FIG. 13, respectively.

The image encoding unit 110 illustrated in FIG. 12 includes a subtraction unit 601, a transform and quantization unit 602, de-quantization and inverse transform unit 603, an addition unit 604, a loop filter unit 605, an image buffer unit 616, a predicted image generation unit 627, an entropy encoding unit 608, and an encoding control unit 629.

The subtraction unit 601 in FIG. 12 is different from the subtraction unit 601 in FIG. 8 in that the subtraction unit 601 in FIG. 12 receives a predicted image from the predicted image generation unit 627 instead of the predicted image generation unit 607. The addition unit 604 in FIG. 12 is different from the addition unit 604 in FIG. 8 in that the addition unit 604 in FIG. 12 receives the predicted image from the predicted image generation unit 627 instead of the predicted image generation unit 607. The image buffer unit 616 in FIG. 12 is different from the image buffer unit 616 in FIG. 10 in that the image buffer unit 616 in FIG. 12 outputs a reference image to the predicted image generation unit 627 instead of the predicted image generation unit 617. The entropy encoding unit 608 in FIG. 12 is different from the entropy encoding unit 608 in FIG. 8 in that the entropy encoding unit 608 in FIG. 12 receives prediction information (which includes, for example, motion vector information) from the predicted image generation unit 627 instead of the predicted image generation unit 607.

The predicted image generation unit 627 acquires an input image 10 and receives a key image 14 from a key image generation unit 120, the reference image from the image buffer unit 616, and prediction control information from the encoding control unit 619. The predicted image generation unit 627 generates a predicted image using the input image 10, the key image 14, and the reference image in accordance with the prediction control information. For example, the predicted image generation unit 627 generates a predicted image by performing intra prediction, performing motion compensating prediction on the reference image or performing prediction based on the key image 14. The predicted image generation unit 627 outputs the predicted image to the subtraction unit 601 and the addition unit 604. Moreover, the predicted image generation unit 627 outputs prediction information on the predicted image to the entropy encoding unit 608.

The encoding control unit 629 generates and outputs prediction control information to the predicted image generation unit 627. The encoding control unit 629 can control the operation of the predicted image generation unit 627 via the prediction control information. Specifically, the encoding control unit 629 can increase the frequency at which the predicted image generation unit 627 performs prediction based on the key image 14. The dependence of decoding of encoded data 15 on the key image 14 increases consistently with the frequency at which the predicted image generation unit 627 performs prediction based on the key image 14. That is, the third person, who is prevented from acquiring the key image 14, fails to easily comprehend the contents of the input image 10 even if the third person acquired the encoded data 15, because the predicted image needed to decode the encoded data 15 is frequently unknown to the third person.

The image decoding unit 210 illustrated in FIG. 13 includes an entropy decoding unit 701, a de-quantization and inverse transform unit 702, an addition unit 703, a loop filter unit 704, an image buffer unit 725, and a predicted image generation unit 726.

The entropy decoding unit 701 in FIG. 13 is different from the entropy decoding unit 701 in FIG. 9 in that the entropy decoding unit 701 in FIG. 13 outputs the prediction information to the predicted image generation unit 726 instead of the predicted image generation unit 706. The addition unit 703 in FIG. 13 is different from the addition unit 703 in FIG. 9 in that the addition unit 703 in FIG. 13 receives the predicted image from the predicted image generation unit 726 instead of the predicted image generation unit 706. The loop filter unit 704 in FIG. 13 is different from the loop filter unit 704 in FIG. 9 in that the loop filter unit 704 in FIG. 13 outputs a filtered image to the image buffer unit 725 instead of the image buffer unit 705.

The image buffer unit 725 receives the filtered image from the loop filter unit 704. The image buffer unit 725 stores the filtered image as a reference image. The image buffer unit 725 outputs reference images to the predicted image generation unit 726 as necessary. Moreover, the image buffer unit 725 supplies the reference images to, for example, the display apparatus not shown in the drawings, as an output image 18 in accordance with the order of display.

The predicted image generation unit 726 receives a key image 17 from the key image generation unit 220, the reference images from the image buffer unit 725, and prediction information from the entropy decoding unit 701. The predicted image generation unit 726 generates a predicted image using the prediction image, the key image 17, and the reference images. For example, the predicted image generation unit 726 generates a predicted image by performing intra prediction, performing motion compensating prediction on the reference images, or performing prediction based on the key image 17. The predicted image generation unit 726 outputs the predicted image to the addition unit 703.

The image encoding apparatus, image decoding apparatus, and key information generation apparatus all included in the image transmission system according to each of the embodiments may be implemented by hardware illustrated in FIG. 14. The hardware in FIG. 14 includes a CPU (Central Processing Unit) 801, ROM (Read Only Memory) 802, RAM (Random Access Memory) 803, a communication IF (Interface) 804, and a bus 805.

Among the CPU 801, the ROM 802, the RAM 803, and the communication IF 804, data transmissions and receptions are performed via the bus 805.

The CPU 801 can operate as a functional unit that executes the above-described various processes. The RAM 803 may be utilized as any of the above-described various buffer units. The communication IF 804 may be utilized to transmit and receive, for example, the key information 13 and the encoded data 15.

The processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image encoding apparatus, comprising:
a key information generator that generates key information;
a key image generator that generates a key image based on a base image and the key information, the base image including one or more images; and
an image encoder that encodes an input image using the key image and generates encoded data.

2. The apparatus according to claim 1, wherein the key information includes identification information indicative of an image selected from the one or more images included in the base image in order to generate the key image.

3. The apparatus according to claim 2, wherein the key information further includes a correction parameter for correcting the image indicated by the identification information.

4. The apparatus according to claim 1, wherein the key information generator searches the one or more images included in the base image for an image most similar to the input image and generates the key information including identification information indicative of a searched-for image.

5. The apparatus according to claim 4, wherein the key information generator searches the one or more images included in the base image for the image most similar to the input image based on supplemental information.

6. The apparatus according to claim 5, wherein the supplemental information includes information on at least one of an imaging date, an imaging time, an imaging position, and an imaging direction.

7. The apparatus according to claim 1, wherein the input image is an image taken by a camera mounted on a first moving body while the first moving body is traveling along a predetermined route, and
the base image is a past image taken by a camera mounted on a second moving body while the second moving body is traveling along the route.

8. The apparatus according to claim 1, wherein the image encoder generates the encoded data by predictively coding the input image using reference images including the key image.

9. The apparatus according to claim 1, wherein the image encoder generates a differential image by subtracting the key image from the input image and generates the encoded data by predictively coding the differential image.

10. The apparatus according to claim 1, wherein the image encoder generates the encoded data by predictively coding the input image using the key image.

11. An image decoding apparatus, comprising:
a key image generator that generates a key image based on a base image and key information, the base image including one or more images; and
an image decoder that decodes encoded data using key image and generates an output image.

12. The apparatus according to claim 11, wherein the key information includes identification information indicative of an image selected from the one or more images included in the base image in order to generate the key image.

13. The apparatus according to claim 12, wherein the key information further includes a correction parameter for correcting the image indicated by the identification information.

14. The apparatus according to claim 11, further comprising a key information generator that generates the key information, and wherein the key information generator searches the one or more images included in the base image for an image most similar to the input image and generates the key information including identification information indicative of a searched-for image.

15. The apparatus according to claim 14, wherein the key information generator searches the one or more images included in the base image for the image most similar to the input image based on supplemental information.

16. The apparatus according to claim 15, wherein the supplemental information includes information on at least one of an imaging date, an imaging time, an imaging position, and an imaging direction.

17. The apparatus according to claim 11, wherein the input image is an image taken by a camera mounted on a first moving body while the first moving body is traveling along a predetermined route, and
the base image is a past image taken by a camera mounted on a second moving body while the second moving body is traveling along the route.

18. The apparatus according to claim 11, wherein the image decoder generates the output image by predictively coding the encoded data using reference images including the key image.

19. The apparatus according to claim 11, wherein the image decoder generates a differential image by predictively coding the encoded data and generates the output image by adding the key image to the differential image.

20. An image transmission system, comprising an image encoding apparatus and an image decoding apparatus, wherein the image encoding apparatus comprises:
a key information generator that generates key information;
a first key image generator that generates a first key image based on a first base image and the key information, the first base image including one or more images; and
an image encoder that encodes an input image using the key image and generates encoded data, and
the image decoding apparatus comprises:
a second key image generator that generates a second key image identical to the first key image based on the key information transmitted by the image encoding apparatus and a second base image identical to the first base image; and
an image decoder that decodes the encoded data transmitted by the image encoding apparatus using the second key image and generates an output image.
